(19) United States
(12) Patent Application Publication
(10) Pub. No.: US 2016/0048758 A1
(43) Pub. Date: Feb. 18, 2016

(54) SYSTEM AND METHOD FOR PERSISTENT EVIDENCE BASED MULTI-ONTOLOGY CONTEXT DEPENDENT ELIGIBILITY ASSESSMENT AND FEATURE SCORING

(71) Applicant: Stanley Victor CAMPBELL, Vienna, VA (US)

(72) Inventor: Stanley Victor CAMPBELL, Vienna, VA (US)

(21) Appl. No.: 14/659,591

(22) Filed: Mar. 16, 2015

Related U.S. Application Data
(60) Provisional application No. 61/927,781, filed on Jan. 15, 2014.

(51) Int. Cl. G06N 5/02; G06F 17/28

(52) U.S. Cl. CPC G06N 5/02; G06F 17/28

(57) ABSTRACT

A system and method configured to provide persistent evidence based multi-ontology context dependent decision support, eligibility assessment and feature scoring. Decisions are achieved via a probabilistic functional extension of both potentiality and plausibility towards nouns in all data forms. Plausibility refers to the full set of values garnered by the evidence accumulation process while potentiality is a mechanism to set the various match threshold values. The thresholds define acceptable confidence levels for decision-making and wherein both plausibility and potentiality are implemented through statistical applications which model and estimate the distribution of random vectors by estimating margins and copula separately from all data types. Evidence is filtered by margins and copula on a persistent basis from the scoring of newly harvested content and refined results are computed on the basis of partial matching of feature vector elements for separate and distinct feature weightings associated with the given entity and each of the reference entities within the compressed copula.

### RELATED APPLICATIONS

This application claims the benefit of U.S. provisional patent application Ser. No. 61/927,781 (filed on Jan. 15, 2014), the disclosure of which is hereby incorporated by reference for all purposes.

### FIELD OF THE DISCLOSURE

This disclosure relates to systems and methodologies for providing decision support, including identify verification and eligibility determinations, within various ontologies and in connection with data that may be unstructured.

### BACKGROUND

Most industries have become extremely dependent on complex data processing systems and large databases to manage day to day operations, business transactions and decision support. In fact, many applications and business processes require cross-industry interfaces and data sharing to manage transactions and provide decision support.

One primary example of such an industry is healthcare and healthcare related services. In this industry there exists a great many disparate categories of companies and governmental regulation further complicates and adds to the number of entities that must communicate and coordinate information in order to process transactions and make decisions. For example, in the healthcare industry, various categories of entities generally need to own, lease or otherwise employ proprietary systems that need to interface with and share data with the systems of other entities in order to coordinate towards the ultimate goal of efficient and affordable patient care.

Within the healthcare industry, entities that need to interface with one another for the purpose of making healthcare decisions and processing insurance benefits may include some or all of the following: hospitals, doctor's offices, patients, insurance companies and their agents, regulatory agencies, laboratories and others. Each of these entities may employ one or more systems for providing, accessing, retrieving and processing data relevant to their business model.

Unfortunately, data models and processing requirements may vary to a great degree between and among these systems even though it is necessary for them to share and collectively communicate and process data. Further, in some cases, data may be largely unstructured lending such data to resulting difficulties in interpreting and processing the data in both the native applications as well as external applications and systems that are designed to receive and process this data.

Within the public and private health and social services markets throughout the world there are multiple disparate and heterogeneous beneficiary and provider systems with no interoperability or standardization. Eligibility adjudication is expensive due to the lifetime maintenance cycles associated with individuals and the requirement for daily updating of systems, processes and rules.

Existing systems for eligibility adjudication tend to operate by using name variants which are compared with other associative content like an individual's date of birth. Matching algorithms generally focus on people or companies separately.

A further impediment associated with the existing framework is that systems are typically required to make their own eligibility determinations. Rather than a single and centralized eligibility construct, multiple decision making processes often occur. These decisions are often inconsistent with each other including having different rules and criteria for making what might be the same or a similar eligibility determination or other decision making process.

Existing eligibility systems typically depend on name match scoring primarily from the comparison models of names of persons or companies within separate structured databases to that of the individual or company being processed. These methods are often inexact and given the number of births and deaths that occur each hour of the day, and due to corporate starts and failures, these methods generally lack persistence and/or accuracy. Existing evidence-combination and data reduction methods primarily use structured data with results being accrued and scored for decisions from content which is often old and easily spoofed.

### SUMMARY

One aspect of the disclosure relates to a system and method configured to provide decision support including eligibility determinations. This system and method has particular application to systems and networks in which disparate data forms exist including data in unstructured formats.

In another aspect of the present invention, decision making is achieved as a probabilistic functional extension of both potentiality and plausibility with respect to nouns rather than with respect to individual names. Further, data in many different forms, not just structured data may be processed in order to provide decision support and eligibility determinations. According to the teachings of the present invention, plausibility refers to the full set of values garnered through the evidence accumulation process and potentiality refers to a mechanism employed to set various thresholds values required for a match determination.

In yet another aspect of the present invention, the aforementioned thresholds define acceptable confidence levels for decision-making. Both plausibility and potentiality functions are extended by statistical applications which model and estimate the distribution of random vectors by estimating margins and copula separately from all data types. Evidence is filtered by margins and copula on a persistent basis via the scoring of newly harvested content. As a result, significantly refined determinations may be computed on the basis of partial matching of feature vector elements for separate and distinct feature weightings associated with the given entity and each of the reference entities within the compressed copula.

In a still further aspect of the present invention, decision support between and among multiple disparate and heterogeneous systems within a network or which otherwise share data and/or interact based on the same data or variants thereof, can be centralized at a single point.

By providing the user with a centralized methodology, system, and apparatus for performing persistent context dependent evidence-based decision-making for eligibility, the common source for matching a given entity against one or more of a set or group of sets from known or reference entities addresses the problem of forcing individual systems to produce their own independent eligibility scoring. This provides unique advantages including, for example, the consistent application of rule for decision support and the ability to operate on a persistent basis on a great many forms of data including data that is unstructured.

The system and method of the present invention performs noun, noun phrase and statistical co-occurrence on structured, unstructured and semi-structured feature data on a persistent basis to produce a common context dependent scoring.

The system and method of the present invention have particular application in a wide variety of industries. For example, and without limitation, the teachings of the present invention may be employed in a number of applications where any or all of matching, eligibility determination, authentication, identification and/or general decision support is required.

Additional exemplary applications associated with the teachings provided herein include the management of biometric identity systems for authentication, including, for example, the use of a photographic device to capture a picture and wherein facial recognition capabilities are used to assist in the identification of an individual. Through this process, the identification activity may then be adjudicated for eligibility for specific ontologically represented occurrences.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates a system configured to provide a decision support, in accordance with one or more implementations;

FIG. 2 illustrates the decision support subsystem of the present invention, in accordance with one or more implementations;

FIG. 3 is a flowchart illustrating a method of performing decision support and eligibility determination in one embodiment of the present invention;

FIG. 4 illustrates an exemplary flow in connection with adjudicating an eligibility determination in accordance with one embodiment of the present invention; and

FIG. 5 is a flowchart illustrating an exemplary process for adjudicating an eligibility determination in accordance with one embodiment of the present invention.

### DETAILED DESCRIPTION

One aspect of the disclosure relates to a computer-implemented system and method for providing decision support and eligibility determinations, the method being implemented in a computer system that includes one or more physical processors and storage media storing machine-readable instructions. The method may be implemented in a computer system that includes one or more physical processors and storage media storing machine-readable instructions.

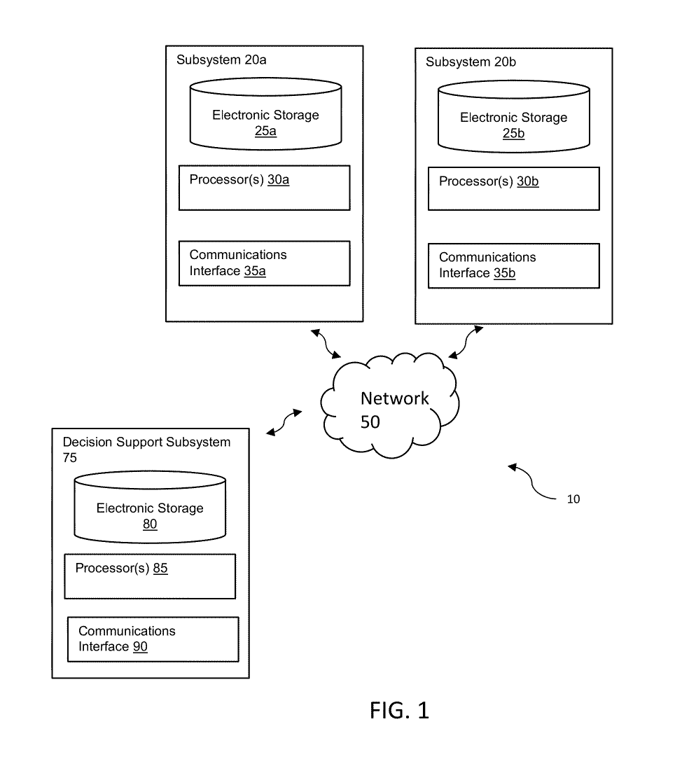

FIG. 1 illustrates one possible configuration of the system 10 of the present invention which includes one or more subsystems 20a, 20b which receive, transmit and process data relative to the specific function of the applicable subsystem. A single subsystem or many more than two subsystems are alternatively possible while still clearly remaining within the scope and spirit of the present invention. By way of example, in a healthcare environment, subsystem 20a may be a hospital data processing system which includes patient data including billing information, patient insurance data and other personal information associated with the patient as well as medical data such as procedures performed and related coding. Further, subsystem 20b may be an insurance company data processing system which receives patient and relating billing information and processes claims including initiating financial transactions and notifying interested parties as the claim process proceeds.

Subsystems 20a and 20b may communicate data between and among each other through network 50 which may comprise the internet, a private network and shared public network or some other network. Each of subsystems 20a and 20b may include electronic storage 25a and 25b which may store the aforementioned data as well as various data concerning other subsystems and various rules associated with processing patient data and insurance claims.

Each of subsystems 20a and 20b may also include one or more processors 30a and 30b for managing the operation of the subsystems as is known in the art. Additionally, each of subsystems 20a and 20b may also include communications interface 35a and 35b for controlling the flow of data received and transmitted by the respective subsystem as well as making and receiving requests and commands from other subsystems via network 50.

Also included within system 10 of the present invention is decision support subsystem 75 which provides a central and single point for decision support and eligibility determination according to the teachings of the present invention as described herein. In the context of a healthcare system, decision support subsystem 75 may provide the functionality associated with determining whether and to what extent benefits associated with specific procedures should be extended to patients or policyholders according to the terms of the insurance contract, regulatory requirements and other rules based schema.

As noted above, decision support subsystem 75 provides a central and single point of decision support/eligibility determination that is consistent and which arbitrates decision making as between all associated subsystems (in this case subsystems 20a and 20b) and which can communicate such determinations to the affected subsystems. In order to make these determinations, as will be explained in further detail below, decision support subsystem 75 preferably receives data from its associated subsystems but also employs local data and rules to make determinations. Such local data may include known or reference entities which is used to match as against a given entity. According to a preferred embodiment of the present invention, these determinations are made on a persistent basis as new data, entities, content and other source data is harvested and made available to system 10.

Decision support subsystem 75 may also include electronic storage 80 for storing the aforementioned rules, known and references entities and data as well as information concerning associated subsystem (in this case subsystems 20a and 20b). Additionally, decision support subsystems 75 may also include communications interface 90 for controlling the flow of data received and transmitted decision support subsystem 75 as well as making and receiving requests and commands from other subsystems via network 50.

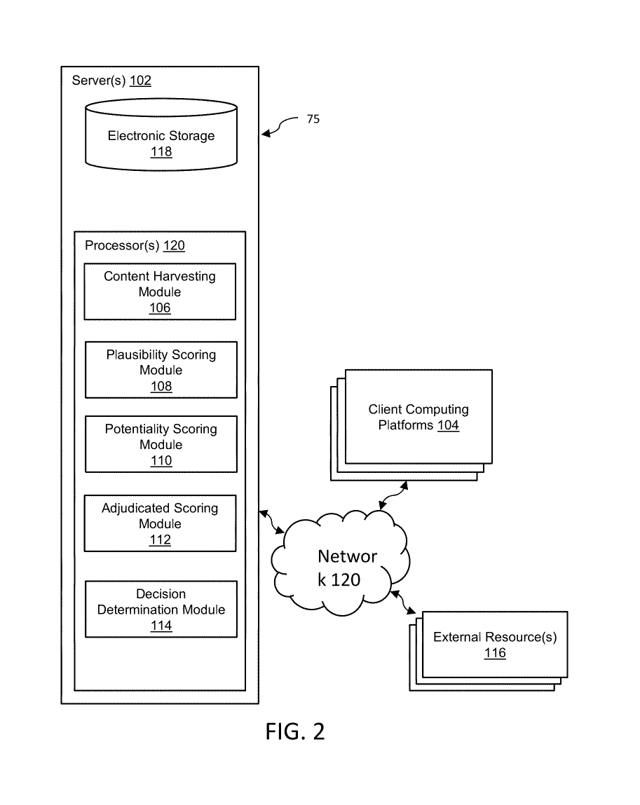

FIG. 2 illustrates one possible embodiment of decision support subsystem 75 configured to provide the decision support and eligibility determination functionality of the present invention in a preferred embodiment thereof. Decision support subsystem 75, as described herein is only one example of a suitable computing environment for such subsystem and is not intended to suggest any limitation as to the scope of use or functionality of the features described herein.

In some implementations, decision support subsystem 75 may include one or more servers 102. The server 102 may be configured to communicate with one or more client computing platforms 104 according to a client/server architecture. The users may access decision support system 75 via client computing platforms 104, for instance, to engage configuration or processing activities. While not shown in either FIG. 1 or FIG. 2, this same configuration may be used to permit users to interact with subsystems 20a and/or 20b which may occur via network 50 or via network 120. Network 50 and network 120 may be either same network or different networks.

The server(s) 102 may be configured to execute one or more computer program modules. The computer program modules may include one or more of a content harvesting module 106, a plausibility scoring module 108, a potentiality scoring module 110, an adjudicated scoring module 112, a decision determination module 114 and/or other modules. As noted, the client computing platform(s) 104 may include one or more computer program modules that are the same as or similar to the computer program modules of the server(s) 102 to facilitate interaction with decision support system 75.

The content harvesting module 106 may be configured to receive and process data, content, entities and other information which is received by system 10 on a persistent basis. The content harvesting module 106 may be further configured to organized the received data according to format(s) determined by system 10 and/or user input including in both structured and unstructured form. In addition, the content harvesting module 106 may be configured to request and receive data on a periodic basis according to a preset schedule which may be as frequent as real time data capture as soon as relevant data is available.

The plausibility scoring module 108 may be configured to process and organize data harvested by content harvesting module 106 and scoring such data on index to determine a plausibility value for evidence accumulation. This process is described in further detail below in a preferred embodiment of the present invention. In some embodiments, plausibility scoring module 108 is located on server 102. The plausibility value which is determined by plausibility scoring module references the full set of values obtained through the content harvesting process and wherein the derived plausibility value technically describes one of many elements in the belief value set, yet refers to the full set of values garnered by the eligibility context accumulation process.

In a preferred embodiment, plausibility scoring module 108 performs noun, noun phrase and statistical co-occurrence on structured, unstructured and/or semi-structured data rather than on just on limited structural elements such as name, social security number and/or date of birth.

The potentiality scoring module 110 may be configured to process and organize data harvested by content harvesting module 106 as well as setting various values for matching thresholds. These thresholds define acceptable confidence levels for decision making and are applied to incoming harvested data to determine matching values. The matching algorithms are extended by statistical applications which model and estimate the distribution of random vectors by estimating margins and copula separately from all data types. Evidence is filtered by margins and copula on a persistent basis from the scoring of newly harvested content and the significantly refined results computed on the basis of partial matching of feature vector elements for separate and distinct feature weightings associated with the given entity and each of the reference entities within the compressed copula.

Further, as with the plausibility scoring module 108 described above, the potentiality scoring module 110 performs noun, noun phrase and statistical co-occurrence on structured, unstructured and/or semi-structured data rather than on just on limited structural elements such as name, social security number and/or date of birth.

In some embodiments, potentiality scoring module 110 is located on server 102. The potentiality value which is determined by potentiality scoring module 110 provides a mechanism for setting various context dependent threshold values, where the thresholds define acceptable confidence levels for decision-making.

Adjudicated scoring module 112 may be configured to determining if an adjudicated scoring exceeds a comparative auto-adjudication threshold, where the automatically determination of at least one provisional rule applies to the eligibility baseline.

Decision determination module 114 may be configured to adjudicate received information corresponding to a context dependent grammar expression of at least one ontology provision where the received information corresponding to an eligibility score is evaluated, thus facilitating the automatic processing of eligibility, based on the rules based determination. In some implementations, decision determination module 114 may be configured to process and make decisions other than eligibility determinations. As noted above, such decision support may involve authentication, identification, matching as well as other applications.

In some implementations, server(s) 102, client computing platforms 104, and/or external resources 116 may be operatively linked via one or more electronic communication links. For example, such electronic communication links may be established, at least in part, via a network such as the Internet and/or other networks. The network may be a wired or wireless network such as the Internet, an intranet, a LAN, a WAN, a cellular network or another type of network. It will be understood that the network may be a combination of multiple different kinds of wired or wireless networks. It will be appreciated that this is not intended to be limiting, and that the scope of this disclosure includes implementations in which server(s) 102, client computing platforms 104, and/or external resources 116 may be operatively linked via some other communication media.

A given client computing platform 104 may include one or more processors configured to execute computer program modules. The computer program modules may be configured to enable a user associated with the given client computing platform 104 to interface with each of subsystems 20a and 20b (as well as additional subsystems if available), system 10 and/or external resources 116, and/or provide other functionality attributed herein to client computing platforms 104. By way of non-limiting example, the given client computing platform 104 may include one or more of a desktop computer, a laptop computer, a handheld computer, a tablet computing platform, a netbook, a smartphone, and/or other computing platforms.

External resources 116 may include sources of information outside of system 10, external entities participating with system 10, and/or other resources. In some implementations, some or all of the functionality attributed herein to external resources 116 may be provided by resources included in system 10.

Servers 102 may include electronic storage 118, one or more processors 120, and/or other components. Server 102 may include communication lines, or ports to enable the exchange of information with a network and/or other computing platforms. Illustration of server 102 in FIG. 2 is not intended to be limiting. Server 102 may include a plurality of hardware, software, and/or firmware components operating together to provide the functionality attributed herein to server 102. For example, server 102 may be implemented by a cloud of computing platforms operating together as server 102.

Electronic storage 118 may comprise non-transitory storage media that electronically stores information. The electronic storage media of electronic storage 118 may include one or both of system storage that is provided integrally (i.e., substantially non-removable) with server 102 and/or removable storage that is removably connectable to server 102 via, for example, a port (e.g., a USB port, a firewire port, etc.) or a drive (e.g., a disk drive, etc.). Electronic storage 118 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 118 may include one or more virtual storage resources (e.g., cloud storage, a virtual private network, and/or other virtual storage resources). Electronic storage 118 may store software algorithms, information determined by processor 120, information received from server 102, information received from client computing platforms 104, and/or other information that enables server 102 to function as described herein.

Processor(s) 120 is configured to provide information processing capabilities in server 102. As such, processor 120 may include one or more of a digital processor, an analog processor, a digital circuit designed to process information, an analog circuit designed to process information, a state machine, and/or other mechanisms for electronically processing information. The processor 120 may be configured to execute modules 106, 108, 110, 112 and 114, by software; hardware; firmware; some combination of software, hardware, and/or firmware; and/or other mechanisms for configuring processing capabilities on processor 120. As used herein, the term “module” may refer to any component or set of components that perform the functionality attributed to the module. This may include one or more physical processors during execution of processor readable instructions, the processor readable instructions, circuitry, hardware, storage media, or any other components.

According to the preferred embodiments of the present invention, various systems, subsystems, components and modules may be included in support of eligibility determinations and other decision support applications. Such components and modules may include, without limitation, the following:
1. A system for performing context dependent, noun based decision-making;
2. A module configured for measuring the relationship between potentiality, plausibility and feature scoring;
3. A module configured for harvesting content and scoring on index for potentiality value for evidence accumulation;
4. A module configured for harvesting content and scoring on index for plausibility value for evidence accumulation;
5. A module configured for harvesting content and scoring on index for noun and phrase parsing value for evidence accumulation from unstructured data;
6. A module configured for processing a noun for eligibility, whereby the module operates to: receive information corresponding to a context dependent grammar expression of at least one provision governing adjudication of a defined ontology and receive information corresponding to the subject of the ontology (health care, gambling, travel, etc.);
7. A module configured for calculating a score representing a confidence that the noun information corresponding to the ontology includes sufficient information to identify the noun and its association with the Ontology (i.e. . . . Traveler's association with the flight, food stamp beneficiary with the application or benefit);
8. A module configured for determining if an adjudicated scoring exceeds a comparative auto-adjudication threshold, wherein the automatic determination of at least one provisional rule applies to the eligibility baseline;
9. A module configured for adjudicating received information corresponding to the context dependent grammar expression of at least one ontology provision where the received information corresponding to the eligibility score is evaluated, thus facilitating the automatic processing of eligibility, based on a rules based determination;
10. A module configured for the storage of information corresponding to one or more ontology structures based on analytic scoring of the context dependent grammar where each node within the ontology represents one or more feature elements and where determination of whether a provision within the ontology applies and its importance (weighting) is completed by associative scoring within the ontology which corresponds to the eligibility adjudication; and
11. A module configured such that at least some nodes within differing ontology structures include continuum values of the common context dependent grammar and wherein the information corresponding to the eligibility assessment includes scoring of the context dependent grammar, and wherein the ontology is traversed to produce persistent scoring which corresponds to one or more ontology structures wherein the specific eligibility is to be determined.

A detailed discussion of the process and system for providing decision support including eligibility determinations is now provided. Embodiments of the invention as described herein are intended to cover exemplary embodiments of the invention and their relationships, rather than to limit the invention or its configuration within the individual elements. The system and methodology of the present invention enables persistent, context and evidence-based decision-making in terms of matching a given entity against one or more of a set of known or reference entities for enterprise wide eligibility and cross eligibility determination on a persistent basis.

A decision is achieved as a function of the context dependent grammar expression of at least one provision. System 10 and the related methodology includes expression of application criteria for the provision. According to the present invention, when determining whether the at least one provision applies to the eligibility context dependency, system 10 evaluates the expression using the received information corresponding to the eligibility ontology for potentiality and plausibility, where plausibility technically describes one of many elements in the belief value set, yet refers to the full set of values garnered by the eligibility context accumulation process.

Potentiality is a mechanism of various context dependent threshold values, where the thresholds define acceptable confidence levels for decision-making. Evidence is computed on the basis of harvesting and matching of feature vector elements where separate and distinct feature vectors are associated with both the given noun entity and each of the context dependent reference entities to achieve a context dependent score. Further, the feature vector association with the ontology need not be initially fully populated, but additional feature vector element values can be obtained as the decision-making process requires.

The computer-implemented method of processing for eligibility invokes the method comprising of the receipt of information corresponding to a context dependent grammar expression of different provisions governing adjudication of the ontology; receiving information corresponding to an eligibility adjudication rules set; calculating a score representing a confidence that the received information corresponding to the ontology includes sufficient information to identify a member noun and associative ontology; and determining if the calculated score exceeds an auto-adjudication threshold. If so, system 10 then determines whether the at least one provision from the context dependent ontology applies to the eligibility function based on the received information corresponding to a context dependent grammar.

Following evidence-combination methods (e.g., those used in Dempster-Shafer and other formalisms), evidence is accrued for the positive, negative and feature dependent decisions on a persistent basis regarding a potential match or cross match between multi ontology structures (for example, a veteran qualifying for health benefits from VA and Medicaid or the same veteran being rejected for Medicaid benefits because he is eligible for VA benefits or individual being eligible to gamble in state A but not in state B and/or not being eligible to consume alcohol within the same or similar environments) based on the received information corresponding to the eligibility ontology, thereby facilitating the automatic and persistent processing of the eligibility determination based on the comparative and calculated crosswalk. The system and methodology of this invention thus provides a single source of persistent eligibility decision-making for multiple situations as opposed to generating a large number of hypotheses.

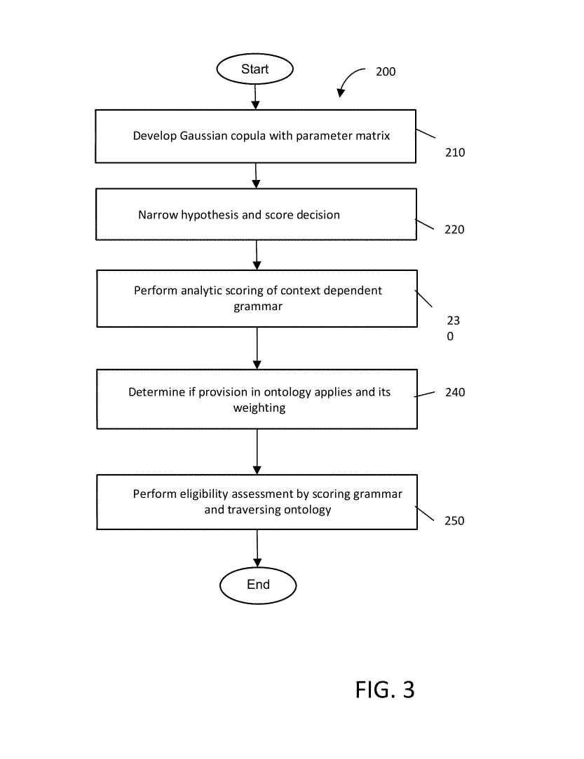

The process of generating a single source for eligibility for a given market and/or for cross market domains is now described with reference to FIG. 3. This process involves the generation of multiple hypotheses and then refuting them to a single reasoned and defensible score. This invention, in a preferred embodiment uses an ontology based rule structure as a means for providing an industry dependent focus which is then used to modulate persistent response and scoring based on continuous data feeds and then associating new data with preliminary information that is used to determine the validity of the initial assertion(s), and to then refute the majority of the non-relevant hypotheses.

As the information sources or determinants become large, copulas are used as statistical applications which model and estimate the distribution of random context dependent feature vectors by estimating margins and copula separately. Parametric models are generalized where the Gaussian copula, for example, for the individual market segments (e.g. medical benefits processing, gaming, authentication, etc.) are represented as a distribution over the unit cube. The persistent baseline is constructed from multivariate normal distributions by using the probability integral Fourier transform.

For a given correlation matrix, and in a preferred embodiment, the Gaussian copula with parameter matrix is developed (step 210). As rule structure ontology dependencies are developed, the hypothesis are narrowed and the decision is scored using Dempster-Shafer (D-S) outputs as opposed to using just a simpler classifier (step 220). Next, using information corresponding to one or more ontology structures analytic scoring of the context dependent grammar is performed wherein each node within the ontology represents one or more feature elements (step 230). Next, determination of whether a provision within the ontology applies and its importance (weighting) is completed by associative scoring within the ontology which correspond to the eligibility adjudication (step 240).

The inverse cumulative distribution function of a standard normal and the sum of all previously adjudicated norms serve as the joint cumulative distribution function of a multivariate normal distribution with mean vector zero and covariance matrix equal to the correlation matrix summation. The density can be written as a Gaussian summation function. At least some nodes within differing ontology structures include continuum values of the common context dependent grammar. The information corresponding to the eligibility assessment includes scoring of the context dependent grammar and the ontology is traversed to produce persistent scoring which corresponds to one or more ontology structures as well as corresponding to the specific eligibility sought (step 250).

In a preferred embodiment, the D-S process produces the belief-set output for each iteration of the D-S process. The feedback and feed forward of successive steps of pairwise evidence parsing and aggregation are compared against market based ontologies to form the belief-set or sets which consist of the continuous variations of resultant evidence based valuations for belief, disbelief, uncertainty, potentiality and plausibility.

According to a preferred embodiment of the present invention, logic gates, if-then relationships and subroutines serve as a group source of persistent eligibility decision-making for multiple situations where, previously, a large number of hypotheses within structured data environments were generated. According to the teachings herein, use cases maximize the identification of “false positives” while if-then relationship maps minimize “false negatives”. These processes are useful when large numbers of disparate operations share the same or similar eligibility determinations or associations where logic gates can be made related to a noun entity, (e.g., determining which person place or thing serving as the reference entity is referred to when an extracted noun or noun phrase entity is taken an indexed from any voice, video, structured or unstructured data, document or other data source).

Process alternatives match to reference entities, matching exact or similar names and extending to advance multiple candidate entity options to prove or disprove each option for the single or multi variant ontology. Processes proving and/or validating, disproving and/or refuting eligibility scoring on a multi-variant basis extends well beyond simple classification or list matching task. If-then classification or list match tasking versus the number of specific classes is generally explicit with few candidate entities that match to a specific class or type. Since classes can be described by combinations of attributes, classification tasks are preferably performed by one of a number of well-known methods, (e.g., Bayesian classifiers, neural networks, etc.). Processes enable matching and scoring particulars for nouns (company or individual name, and/or place against both a large set of reference nouns and an ontology structure for individual or multi eligibility instances. Logic gates referencing noun entities are characterized, scored and weighted independently and uniquely by a set of elements and not by the nature of given class.

In a preferred embodiment, for each system 10 is configured with the market ontology which provides the algorithmic decision-making process, based on market valuations for eligibility within a given belief-set. According to one embodiment, the present invention may comprise embodiments which include other novel functionalities such as some or all of the following: (1) a method for performing context dependent noun adjudication and iterative hypothesis generation, (2) a method for relationship mapping for plausibility together with hypothesis validation and refutation, (3) a method for harvesting and scoring for potentiality under the guidance of an appropriate rules set for gathering evidence, (4) a method for scoring the harvested content through a feature vector scoring mechanism, (5) a method for making decisions related to market focused eligibility using noun and noun phrase parsing and statistical co-occurrence and using a combination of belief values (belief, disbelief, and uncertainty, along with conflict), (6) a method for embedding ontology based context dependent decision points and thresholds for achieving successful eligibility validation or refutation within a context, termed a potentiality framework; (7) a method for enabling a feature vector node for each extracted entity (person, place or thing), where each node in the market ontology serves as a weighted feature vector and the “parent-child” feature relationships are scored with weightings and distance measures. For example, company name may be viewed as the central node, with address, employee role, supplier and client relations, etc. serving as associations within the sub-ontology. One novel aspect is that, for example, a person's name may be scored as a sub-ontology rather than as a primary within a system where the individual's eligibility is key to the decision making process. The direct comparative is where the person's workplace (company) serves as sub-ontology.

According to the preferred embodiments, most, if not all of the individual modules can be changed or adjusted to meet the intended form, fit, and functionality of the system. There exist many Bayesian probability functions where one of the different interpretations of the concept of probability may belong or be used to the category of evidential probabilities. The Bayesian interpretation of probability, including the feature vector function can be seen as an extension of propositional logic that enables reasoning with propositions whose truth or falsity is uncertain.

The Dempster Shafer classification algorithm is used in a preferred embodiment to assist in the evaluation of the probability of a hypothesis, however the Bayesian probability may also be employed to specify some prior probability, which is then updated in the light of new, relevant data. Additional Markov chain Monte Carlo (MCMC) methods (which include random walk Monte Carlo methods) serve as a class of algorithms for sampling from probability distributions based on constructing a Markov chain that has the desired distribution as its equilibrium distribution. The state of the chain after a large number of steps can be used to mimic the methods of the present invention which may be used as a sample of the desired market based patch for eligibility distribution.

The quality of the sample improves as a function of the number of steps and the convergence of a Metropolis-Hastings type algorithm may be used to approximate the multi-ontology based distribution. The Markov chain may be configured with the desired properties based on the ontology. The Bayesian interpretation provides a unique set of procedures and formulae to perform the persistence and accuracy calculations. In contrast to interpreting probability as the “frequency” or “propensity” of some phenomenon, the present invention's use of Bayesian probability is that of a feature vector weighting quantity that is assigned for the purpose of representing a state of knowledge at a point in time, for a specific ontologically based purpose.

The system and methodologies of the present invention may be implemented in a wide variety of ontologies including in various industries, markets and for a practically unlimited set of applications. In each of these cases, the practical benefits of the teachings of the present invention are leveraged so as to provide consistent and efficient processes for decision making including with respect to eligibility determination. One representative example where the present invention may be employed is with respect to single source adjudication for eligibility in the context of matching algorithms implemented by the Transportation Safety Administration (TSA) and other governmental entities that assess the eligibility of individuals to fly on commercial flights. In more colloquial terminology, one of the major stated goals is to ensure that individuals who are on the “no-fly” list are not, in fact, permitted to board commercial aircraft.

In connection with this process, persons who desire to book a commercial flight must provide personal and demographic information to airlines in order to book the flight. Under one exemplary program, persons who meet the criteria of being “Transportation Workers” under the government's Transportation Worker Identification Credential (“TWIC”) program may be required to participate in the program. This program involves the use of a smart card identification element which stores the individual's name, a digital phone, fingerprints and an expiration date. This program is separately managed from other TSA programs and eligibility determinations for maritime and airport access are made independently from determinations associated with, for example, the TSA certified “fast lane” passenger systems. As such, the data for each passenger is transacted in different systems. Applying the teachings of the present invention to the present environment for authentication under the multiple TSA programs could result in a single source identity verification protocol which would be much more efficient and consistent in terms of eligibility determination.

Another example is with respect to health care services and eligibility determinations for insurance as currently implemented. The Office of Management and Budget estimates that the value of unrecovered improper payments made for health care services, exceeded $10 billion per year in 2007 and 2008, and exceeded $24 billion in 2009 with an estimated 2 percent increase per year. Of the over $130,000,000 per day in losses, approximately $30,000,000 represents losses from Medicare eligibility issues alone. This is to a great degree, the result of the current framework which requires the administration of over 400 disparate federal and state health related sources.

Federal health related sources includes the Department of Veterans Affairs, Federal Prisons, recovery and other audit contractors, Medicare administrative contractors and many others that all have to depend on disparate developed and managed databases for non-persistent review. All of these systems have separate provider and beneficiary eligibility systems. Of the approximately $70,000,000 per day in losses from de-centralized health related eligibility, the federal and state systems represent less than 40% of the health related eligibility expenditures.

The Food Stamp, CHIP, and other health and human services activities are not considered within the above examples, however their independent eligibility ontology is based on approximately 90% of the feature vector analytic criteria for Medicare or Medicaid. The healthcare industry infrastructure lacks a common eligibility adjudication source and also lacks any persistence even within the disparate sources as they exist today. Eligibility for a simple physical on a veteran over the age of 65 who retired with health benefits could invoke over 8 disparate coverage agreements between different health care entities and over 12 if the individual received a prescription. Most of these agreements include hundreds of different coverage provisions which in some cases reference one another but in most cases do not, thus making single source, persistent, multi-ontology eligibility as disclosed in the present invention critical to the next generation of health and human service administration.

Yet another possible implementation for the present invention is with respect to “on-line gaming” where there does not currently exist a realistic adjudication for eligibility in an environment where each occurrence of a minor participating in the use of the infrastructure represents a criminal act. The present invention can be used in conjunction with biometric devices for eligibility scoring and for market profiling of individuals for financial eligibility to make profiles based on a specific ontology.

Similarly, the present invention can be used as the basis for eligibility/authentication determinations in connection with biometric identity systems for authentication. For example, the system and methodologies of the present invention may be employed in connection with the use of a photographic device to capture a picture wherein facial recognition software is used to assist in the identification of the individual. In this case, the data is then adjudicated for eligibility for specific ontologically represented occurrences.

The foregoing possible applications of the teachings of the present invention are merely exemplary and should not be viewed as limiting. The system and methods of the present invention have broad applicability to any application where single source decision making is desired including within a great many ontologies and industries.

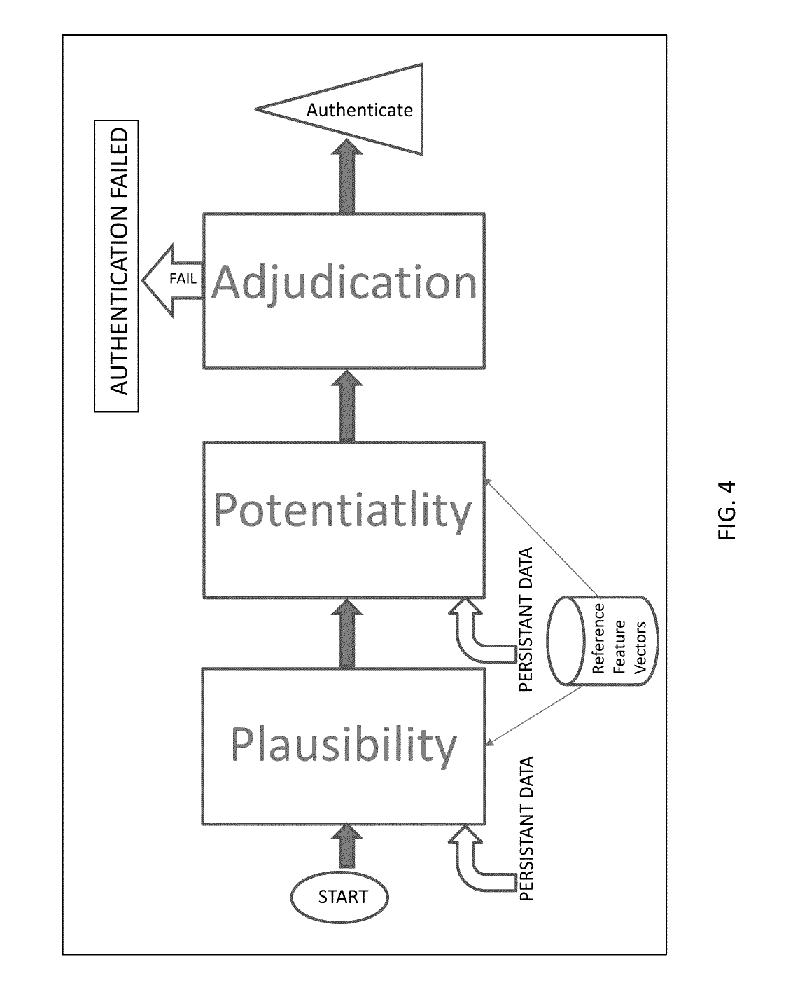

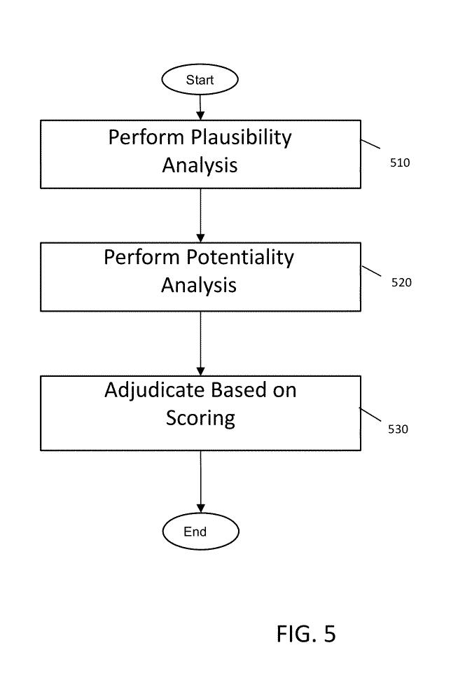

An exemplary embodiment of the system and method of the present invention is now described with reference to FIGS. 4 and 5. By way of example and not limitation, the present description is provided in the context of performing an eligibility determination with respect to an individual seeking reimbursement for a routine physical examination based on a health insurance policy that that individual has in place with a healthcare insurance policy provider.

In order to perform the eligibility determination, one of the necessary steps is to first ensure that the identifying data associated with the individual seeking the benefits matches with known reference data tied to the insurance policy or other risk entity. In other words, it is first necessary to validate that the proposed transaction is authorized in that the individual seeking benefits actually maintains an insurance policy which provides the desired benefits under their specified formulary. The first step in this process, before even determining whether and to what extent benefits are available is to validate that the individual even has a policy referenced within the system.

According to the present invention and assuming that the reference data is available as one or more reference feature vectors stored within the system, a plausibility analysis (step 510) may be performed upon the persistent data arriving into the system. In the plausibility analysis, as noted above, the goal is to obtain an indexed score based on the evidence accumulation associated with the analysis. This may occur, in some embodiments, through the capture and receipt of a context dependent grammar expression relevant to the analysis. By way of example and in the present case, such an expression may comprise a noun phrase indicative of the individual's status as a policyholder. As an example, for medication eligibility, this noun phrase could include, with patient demographic data (name, address, date of birth, social security number, patient identification etc.), any combination of the policy or plan name or number, the group plan name or number, the medication Bank Identification Number (BIN), the medication Processor Control Number (PCN), Pharmacy Benefits Manager (PBM), Pharmacy Processor; etc.

The system of the present invention also employs relationship mapping to make a plausibility determination to include hypothesis validation and refutation by applying weighed scoring to each individual feature element and their contextual combination. As a second set of scoring, functions which may be modeled for patient eligibility scoring may include many other features of interest reflective of the individual's healthcare landscape. These scorable features for specific eligibility may include, for example:
Vital Signs, including: height, weight, temperature, respiration, blood pressure, and pulse (change across time and may be correlated to conditions and afflictions)
Blood Type, Organ Donor Status, Family Medical History, and Medical Advance Directives
Emergency contact information (including full demographics and contact information of identified individuals)
Primary healthcare provider (including full demographics and contact information of identified providers)

Scoring may be relative to the full set of evidence values reflected as a distribution of random vectors and employing one or more copula functions to identify and model the applicable dependence structures. The multivariate distributions associated with the analysis can be processed such that the univariate margins and dependence structure can be separated with the latter being represented by a copula. Because copulas have the beneficial property of invariance under increasing transformations of the margins, the estimation and modeling can be performed by first modeling each univariate marginal distribution and then by specifying a copula which summarizes the dependencies between margins. As noted above, in a preferred embodiment of the present invention, the Dempster-Shafer (D-S) model is preferred over a simple classifier.

The potentiality determination (step 520) involves the setting of various match thresholds required for matching. These thresholds define acceptable confidence levels for considering the persistent data as a match against reference data. In connection with this process, modeling and estimation of the distribution of random vectors is employed to determine the most relevant and desirable thresholds.

As an example, demographics may be used to established potentiality according to configurable population norms, defined distributions and changeable processes. Once a patient is generated in the independent Electronic Medical Record (EMR), medication coupon, co-payment or other patient engagement workflow, processes or environment the system consistently maintains each demographic feature, longitudinally, according to each potentiality element, rules, dependencies and constraints. Patient demographics can thus be shared by and between disparate EMR's or other workflow or platforms including, for example:
Age, gender and marital status
Occupation
Race and Ethnicity
Address

At step 530, an adjudication process is initiated. If the scoring falls short of the minimum threshold, the authentication fails and the transaction is rejected. In this instant case, this may trigger a notification to the interested entities such as any or all of the healthcare providers, the insurance companies, other risk entities, pharmacy benefits managers, other medication risk entities and/or the individual.

The potentiality function also scores patient eligibility conditions longitudinally and uses one or more processors to perform patient population eligibility stratification across demographics, affliction models and other healthcare encounter elements as well as conditional elements which might be present for measure at the time of the encounter. The affliction associated eligibility model assigns plausibility and potentiality conditions to patients according to each patient's age, gender, medications and other demographic, clinical, environmental and sensor data. The eligibility processors are configured to track and classify the severity of the condition at the time of an encounter and to set the eligibility functions related to the insurance or other risk formulary.

Each encounter, establishes eligibility functions within the patient as a set of specific weightings associated with symptoms for each condition, consistent with its given severity, at the time of the encounter. This eligibility functionality is used in the stratification of the patient population and its measures are used to identify the population risk and eligibility for specific care functions.

The affliction eligibility scoring function may also be used to stratify and score disease within a population (COPD eligibility for mild, moderate, moderate to severe and severe condition severity scoring). The following are examples of patient condition aspects that the affliction eligibility model may establish at the time of an encounter:
Condition severity
Correlated condition symptoms, including the severity of each symptom (gender specific)
Vital signs, such as fever, to be consistent with the established symptoms
Allergies (Allergen, Severity and Reaction)
Diagnostic Testing and Health Screenings

To perform this scoring, the system establishes a series of outbreak date/location loci, each of which includes its own set of age/gender specific eligibility affliction rates. The full set of evidence values are reflected as a distribution of random vectors and employing one or more copula functions to identify and model the applicable dependence structures. The eligibility affliction plausibility and potentiality function inspects individual patient elements to see if they are to be within any of the defined outbreak loci, and if so, determines if they will be candidates for contracting the disease.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present disclosure contemplates that, to the extent possible, one or more features of any implementation can be combined with one or more features of any other implementation.

What is claimed is:

1. A decision support system configured to provide single source and centralized decision making, the decision support system comprising:
one or more processors configured to execute computer program modules, the computer program modules comprising:
a content harvesting module configured to receive persistent content;
a plausibility scoring module configured to perform hypothesis validation and refutation functions and generate a plausibility scoring value;
a potentiality scoring module configured to set confidence thresholds for decision making and generate a potentiality scoring value; and
a decision determination module configured to adjudicate the potentiality scoring value and the plausibility scoring value as against threshold values and render a decision based thereon.

2. The decision support system of claim 1 wherein said persistent content comprises nouns.

3. The decision support system of claim 1 wherein said persistent content comprises noun based phrases.

4. The decision support system of claim 1 wherein said plausibility scoring value is determined based upon a confidence level related to whether or not said content includes sufficient information to identify said content as well as said content's association with a specified ontology.

5. The decision support system of claim 1 wherein said content is represented as feature vector elements.

6. The decision support system of claim 1 further comprising a reference data storage module, said reference data storage module storing reference data which is matched as against said persistent content.

7. The decision support system of claim 6 wherein said reference data is stored in the form of feature vector elements.

8. The decision support system of claim 1 wherein said plausibility scoring module generates said plausibility scoring value by employing at least one copula function to identify and model applicable dependence structures.

9. The decision support system of claim 1 wherein said potentiality scoring module generates said potentiality scoring value by employing at least one copula function to identify and model applicable dependence structures.

10. The decision support system of claim 1 wherein said decision represents a patient eligibility determination.

11. A computer-implemented method of providing decision support, the method being implemented in a computer system comprising one or more processors configured to execute computer program modules, the method comprising:
receiving persistent content;
performing hypothesis validation and refutation functions and generating a plausibility scoring value;
setting confidence thresholds for decision making and generating a potentiality scoring value; and
adjudicating the potentiality scoring value and the plausibility scoring value as against threshold values and rendering a decision based thereon.

12. The method of claim 11 wherein said persistent content comprises nouns.

13. The method of claim 11 wherein said persistent content comprises noun based phrases.

14. The method of claim 11 further comprising the step of determining said plausibility scoring value based upon a confidence level related to whether or not said content includes sufficient information to identify said content as well as said content's association with a specified ontology.

15. The method of claim 11 wherein said content is represented as feature vector elements.

16. The method of claim 11 further comprising the step of storing reference data which is matched as against said persistent content.

17. The method of claim 16 wherein said reference data is stored in the form of feature vector elements.

18. The method of claim 11 wherein said plausibility scoring module generates said plausibility scoring value by employing at least one copula function to identify and model applicable dependence structures.

19. The method of claim 11 wherein said potentiality scoring module generates said potentiality scoring value by employing at least one copula function to identify and model applicable dependence structures.

20. The method of claim 11 wherein said decision represents a patient eligibility determination.
